(19) United States
(12) Patent Application Publication
(10) Pub. No.: US 2025/0215918 A1
(43) Pub. Date: Jul. 3, 2025

(54) DEVICE FOR RETAINING A MOVING PART

(71) Applicant: ETA SA Manufacture Horlogère Suisse, Grenchen (CH)

(72) Inventors: Raphaël BALMER, Vicques (CH); Raphaël COURVOISIER, Corcelles (CH)

(73) Assignee: ETA SA Manufacture Horlogère Suisse, Grenchen (CH)

(21) Appl. No.: 18/915,596

(22) Filed: Oct. 15, 2024

(30) Foreign Application Priority Data
Dec. 27, 2023 (EP) 23220359.6

(51) Int. Cl. F16B 21/18

(52) U.S. Cl. CPC F16B 21/183

(57) ABSTRACT

A device is for axially retaining a moving part of a horological movement about a shaft, the moving part including a cylindrical part arranged to be mounted coaxially on the shaft, the device including a clip intended to be mounted on the cylindrical part of the moving part. The clip includes a resilient retaining structure arranged to cooperate with the cylindrical part and to grip the cylindrical part over part of its periphery, and includes a locking beak passing through an opening extending radially inwards relative to the cylindrical part, the locking beak being arranged to cooperate with a slot in the shaft to hold the moving part axially in place.

### TECHNICAL FIELD OF THE INVENTION

The invention relates to the field of horology, and in particular to the field of watches. The invention relates more particularly to a device for retaining and rotatably guiding a moving part of a horological movement.

### TECHNOLOGICAL BACKGROUND

The prior art includes numerous documents relating to devices for retaining moving parts.

It discloses the fastening of the moving parts of a movement by means of a screw, by driving them onto an arbor or by using a retaining ring. For example, moon phase display discs are typically held by a screw or an arbor in their centre, or even by a guide ring, which can increase the thickness of the movement.

Another conventional way of guiding a horological moving part is to make it pivot between two bearings, each supported by a blank (plate, cock, retaining plate, etc.).

For functional reasons, in particular due to wear and lubrication, a bearing is typically a component assembled to a blank and thus requires assembly operations. The bearing can be metallic or mineral, and bearings are known to be made of brass or bronze, etc. or to be made of ceramic or ruby, etc.

This architecture thus requires the manufacture and assembly of various components, and is costly both in economic terms and in terms of the space occupied in the movement.

A cost-effective way of overcoming this problem is to simply remove one of the blanks. If the moving part in question is an hour wheel, it is inserted onto the cannon-pinion, which acts as a radial guide and axial stop element in one direction only (towards the gear train side).

In the other direction (towards the dial side), the hour wheel is not retained until the watch dial is fitted. In such a case, a movement cannot be provided without a dial, such as a so-called “skeleton” movement, because without an axial stop on the dial side, the moving part will not remain in position. It is also clear that delivering such a movement for insertion into a watch case cannot be done easily with this type of moving part.

Various solutions exist, but they all have their drawbacks:
the moving part must be delivered as a spare part. As a result, lubrication, which is very delicate, must be carried out by the case fitter (who is not experienced in this field) and not by the movement assembler;
the movement must be delivered in a protective container, the cover whereof acts as a stop. If the moving part in question is an hour wheel, this moving part will exist in various lengths in order to be able to protrude in a manner adapted to the different dial thicknesses that will be mounted on this movement. This solution solves the lubrication problem, but requires the use of a protective container cover that is adapted to each moving part length, which makes the logistics much more complex;
the movement must be delivered with a retaining clip. This clip must be inserted when assembling the movement. This solution solves the lubrication problem and logistics regarding the protective containers. However, this component must be manufactured and assembled merely in order to be able to deliver a movement to a case fitter. Given the small size of the component, it is difficult to wash and recondition, making it difficult to reuse. Finally, when it is removed, there is a high risk that the movement will be damaged, for example due to excessive force caused by being extracted in the wrong direction, or that it will be scratched by the extraction pliers.

It should be noted that none of the proposed solutions solves the problem of a movement without a dial. This is because the solutions described only allow a movement to be delivered to a case fitter, but in no way allow it to be kept in a functional state once it has been fitted.

The prior art does not offer an affordable and easy-to-implement solution, resulting in a need to offer an alternative to existing solutions.

### SUMMARY OF THE INVENTION

The purpose of the present invention is to overcome the drawbacks of the prior art by proposing a device for axially retaining two coaxial elements, at least one of which is rotary, by the radial insertion of a clip which generates no or very little friction torque with the first element, even though it is integral with the second element.

The invention thus relates to a device for axially retaining a moving part of a horological movement about a shaft, the moving part comprising a cylindrical part arranged to be mounted coaxially on the shaft, the device comprising a clip intended to be mounted on the cylindrical part of the moving part.

According to the invention, the clip comprises resilient retaining means arranged to cooperate with a groove made in the cylindrical part and to grip the groove, and comprises a locking beak passing through an opening extending radially inwards relative to the cylindrical part, and cooperating with a slot in the shaft to hold the moving part axially in place.

According to other advantageous alternative embodiments of the invention:
the cylindrical part comprises a groove formed around all or part of its periphery;
the clip has a ring body that has two arms with open ends, at least one of the two arms being resiliently deformable, the arms forming the retaining means;
the clip has an inner radius that is smaller than the radius of the cylindrical part or of the groove in order to obtain resilient deformation of the resilient retaining means and to ensure that they are retained without play on the cylindrical part;
the clip comprises handling means;
the beak is placed at one of the open ends;
the ring body has two circular arcs per arm;
the locking beak is longer than the depth of the opening;
the clip is made from a wire;
the clip has an elliptical shape so that only the ends of the arms rest in the groove against the periphery of the cylindrical part and the locking beak in the opening;
the device comprises a metal foil arranged on the moving part, with the clip retaining both the moving part and the metal foil.

According to another aspect, the invention relates to a movement comprising a device according to the invention.

### BRIEF DESCRIPTION OF THE FIGURES

Other features and advantages of the invention will become apparent from the following detailed description, which is given by way of example and is by no means limiting, with reference to the accompanying drawings in which:

FIG. 1 is a perspective view of the device according to the invention, which device is in the locked position;

FIG. 2 is a perspective view of the device according to the invention, which device is in the unlocked position;

FIG. 3 is a sectional view of a device according to the invention;

FIGS. 4a to 4d illustrate alternative embodiments of the invention.

### DETAILED DESCRIPTION OF THE INVENTION

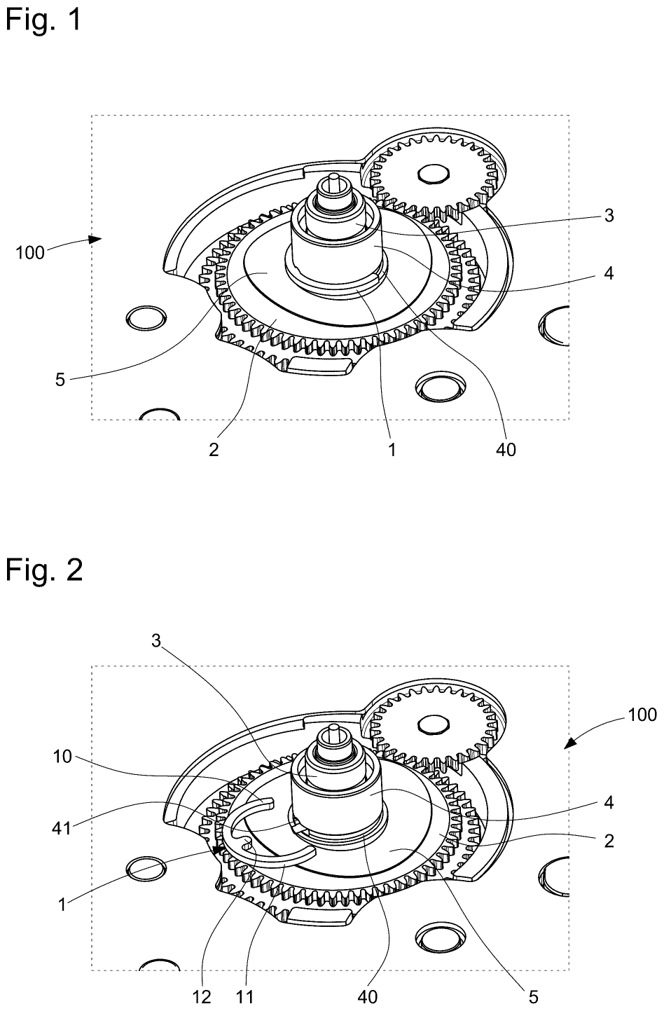

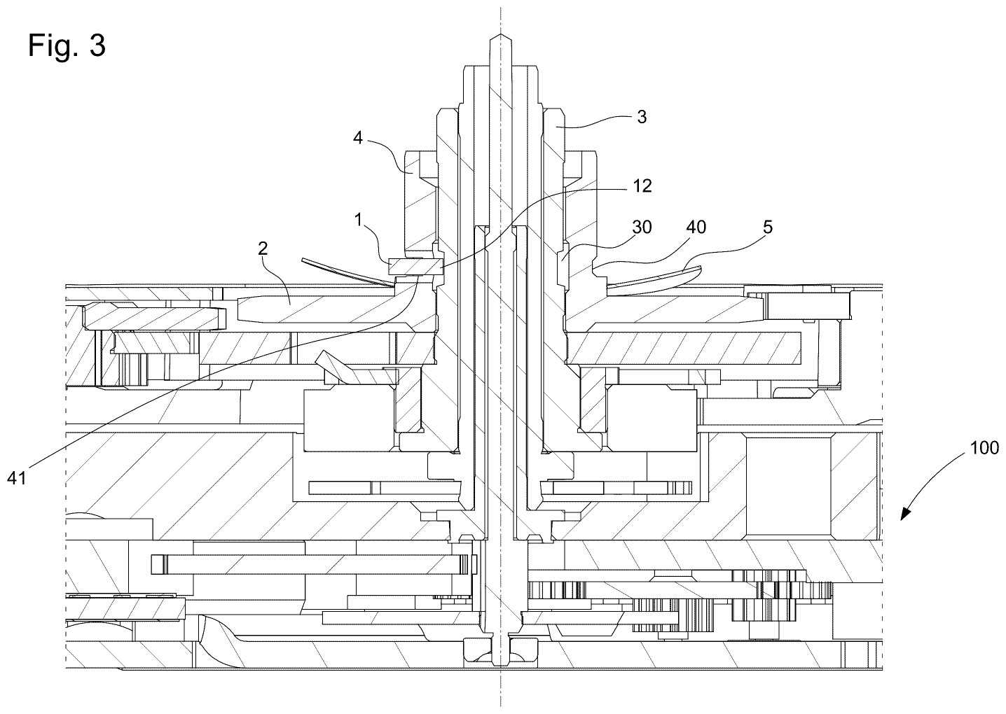

A device for retaining an hour wheel on a barrel according to the invention will now be described by way of example with reference to FIGS. 1 to 3. A person skilled in the art will have no difficulty in adapting the device to any other type of moving part, whether or not it pivots about a rotary shaft.

According to the illustrated embodiment, the horological movement is intended for the design of a timepiece comprising a moving part constituting an hour display and thus comprises a device for driving this moving part, the structure of such a drive device being known and will not be described further here.

It goes without saying that the invention applies to any type of moving part that pivots about a shaft, for example a moving part for displaying the moon phase, the minutes, the date, a lever or even an intermediate wheel.

The invention relates to a device for retaining a moving part 2, such as a wheel of a horological movement 100, mounted on a shaft 3. The device comprises a clip 1 intended to be mounted on the barrel 4 of the moving part 2 and to cooperate with the shaft 3 between a first and a second position.

Advantageously, the clip 1 comprises resilient retaining means 10, 11 in the form of two arms intended to cooperate with the barrel 4, or with a groove 40 made in this barrel, as well as a locking beak 12 intended to cooperate successively with an opening 41 in the barrel 4 and a slot 30 in the shaft 3 to hold the moving part 2 axially on the shaft 3 in the first position and to leave this moving part 2 axially free in the second position, the clip 1 being intended to be able to move translatably between the first position, referred to as the locked position, and the second position, referred to as the unlocked or free position, in which it can be removed.

As shown in FIG. 1, the clip 1 takes the form of a ring body having two arms 10, 11 with open (or free) ends, each arm being resiliently deformable to grip the groove 40 when the clip 1 is mounted on the barrel 4, the groove 40 extending continuously (or partially) around the circumference of the barrel 4.

As shown in the figures, the clip 1 also has a locking beak 12 which lies in the same plane as the plane formed by the two arms 10, 11.

The clip 1 comprises a locking beak 12 which passes through the opening 41 made in the barrel 4 and the end of which rests in the slot 30 in the shaft 3 to hold the moving part 2 axially on the shaft 3, the clip 1 thus preventing the moving part 2 from sliding along the shaft 3.

The locking beak 12 has a length greater than the depth of the opening 41, and slightly less than the distance between the bottom of the slot 30 and the base of the beak 12, to prevent friction between the beak 12 and the shaft 3 and ensure that the moving part 2 is held securely on the shaft 3.

The cooperation of the resilient retaining means 10, 11 with the groove 40 makes it possible to both guide and reliably hold the clip 1 on the moving part 2. Thus, once the clip 1 is in place, the moving part 2 cannot become dislodged from the shaft 3 as the clip 1 prevents the moving part 2 from moving axially along the shaft 3. Such an arrangement is particularly useful for delivering movements before they are fitted in a case, because the moving parts can be mounted and held in place while the movements are being delivered.

Advantageously, the clip 1 only grips the barrel 4, so no gripping torque is transmitted to the shaft 3.

According to the embodiment shown in FIG. 2, the arms 10, 11 of the clip 1 have an inner radius that is smaller than the radius of the barrel 4 or of the groove 40 in order to resiliently deform the arms 10, 11 of the clip 1 and hold it in place on the barrel 4 without play.

It should also be noted that the clip 1 can be used to axially retain elements other than the moving part 2, such as a metal foil 5 placed on the moving part 2, for example. The clip 1 can thus be used to axially retain a plurality of elements at the same time.

The clip 1 can be made of a material chosen from among resiliently deformable plastics materials or metals.

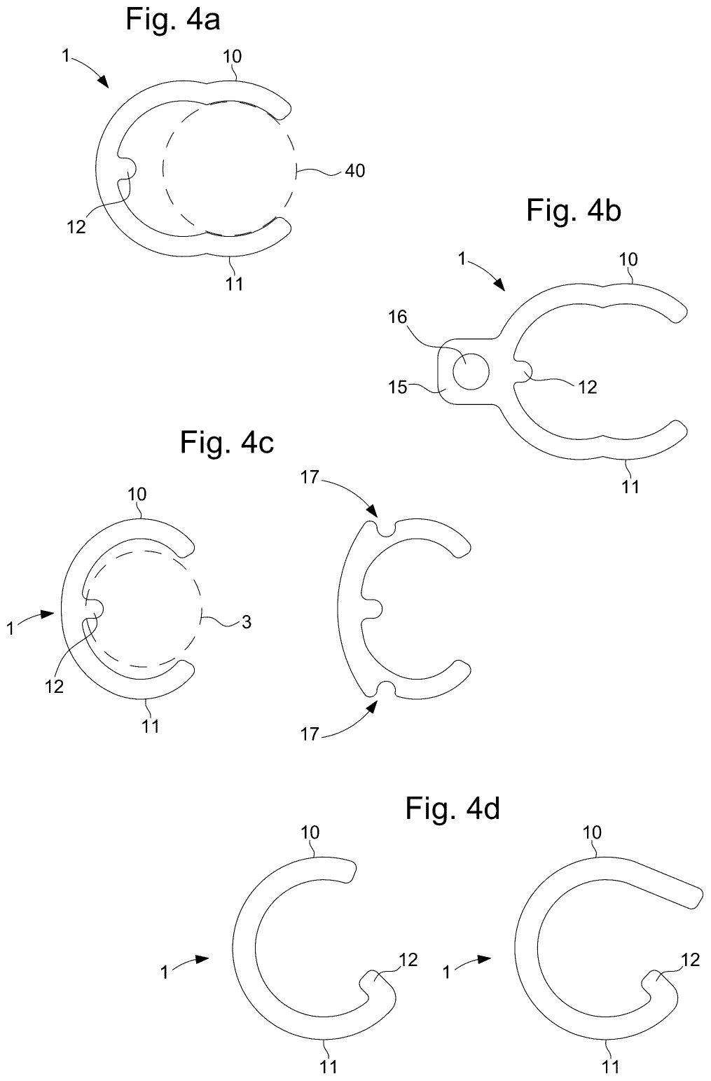

According to an alternative embodiment shown in FIG. 4a, the ring body of the clip 1 has two circular arcs per arm 10, 11. Such an arrangement makes it possible to form a stop notch and two positions that are easily distinguishable by the operator, while preventing the clip from being lost.

The clip 1 can further comprise handling means, such as a tab 15 optionally provided with an opening 16 to facilitate handling of the clip 1, as illustrated in FIG. 4b. The arms 10, 11 can optionally have an elliptical shape so that only the ends of the arms 10, 11 rest in the groove 40 against the periphery of the shaft 2 so as to become the handling means optionally provided with openings 17 to facilitate handling of the clip 1, as illustrated in FIG. 4c.

According to yet another alternative embodiment shown in FIG. 4d, the clip 1 is also in the form of a ring body with two arms 10, 11 having open ends, and one of the ends 10 or 11 of which is bent inwards relative to the clip 1 to form the locking beak 12 arranged to cooperate with the opening 41 in the barrel 4.

The clip 1, as shown in FIG. 4d, is positioned on the shaft 3 as follows: firstly, the bent end forming the locking beak is placed in the opening 41 in the barrel 4. The other open end is then passed around the barrel so that the free arm runs along the groove 40 and engages therein until the clip occupies its locked position.

In the other alternative embodiments shown in the drawing, the clip 1 is positioned on the shaft 3 as follows: firstly, the clip 1 is positioned on the barrel 4, with the locking beak facing the opening 41 and the arms pre-engaged in the groove 40 so that the clip 1 is guided over the barrel 4. The operator then pushes the clip 1 such that it abuts against the barrel 4 in order to pass the locking beak 12 through the opening 41 until it enters the slot 30 in the shaft 3 and until the clip occupies its locked position.

The clip 1 is removed in the opposite direction to that of its insertion. In the particular case of the alternative embodiment illustrated in FIG. 4c, the inner radii of the arms are not coaxial with the radius of the barrel 4 or of the groove 40. This allows a radial stress, directed towards the centre of the barrel, to be exerted in order to spread the open ends of the arms 10, 11 apart to facilitate extraction of the clip. In such a case, the openings 17 can be used to hold the ends of a tool on the clip 1, without the risk of the tool slipping and damaging the movement.

Thanks to these various aspects thereof, the invention provides a device for retaining a moving part of a horological movement that is easy to mount/remove and that provides a reliable hold of the moving part on its shaft during the transport of the horological movements.

The above description corresponds to a preferred embodiment and can under no circumstances be considered to be limiting, and more particularly as regards the form described for the different structural elements composing the assembly device or the materials thereof.

1. A device for axially retaining a moving part of a horological movement about a shaft, the moving part comprising a cylindrical part arranged to be mounted coaxially on the shaft, the device comprising a clip intended to be mounted on the cylindrical part of the moving part,
wherein the clip comprises resilient retaining means arranged to cooperate with the cylindrical part and to grip the cylindrical part over part of its periphery, and wherein the clip comprises a locking beak passing through an opening extending radially inwards relative to the cylindrical part, the locking beak being arranged to cooperate with a slot in the shaft to hold the moving part axially in place.

2. The device according to claim 1, wherein the cylindrical part comprises a groove formed around all or part of its periphery.

3. The device according to claim 1, wherein the clip has a ring body that has two arms with open ends, at least one of the two arms being resiliently deformable, the arms forming the retaining means.

4. The device according to claim 1, wherein the clip has an inner radius that is smaller than the radius of the cylindrical part or of the groove in order to obtain resilient deformation of the resilient retaining means and to ensure that they are retained without play on the cylindrical part.

5. The device according to claim 1, wherein the clip comprises handling means.

6. The device according to claim 1, wherein the beak is placed at one of the open ends.

7. The device according to claim 1, wherein the ring body has two circular arcs per arm.

8. The device according to claim 1, wherein the clip is made from a wire.

9. The device according to claim 1, wherein the clip has an elliptical shape so that only the ends of the arms rest in the groove against the periphery of the shaft and the locking beak in the opening.

10. The device according to claim 1, wherein the clip comprises a metal foil arranged on the moving part, with the clip retaining both the moving part and the metal foil.
